(19) United States
(12) Patent Application Publication
(10) Pub. No.: US 2021/0207018 A1
(43) Pub. Date: Jul. 8, 2021

(54) Hyperbranched Polymers For Subterranean Umbilical Applications

(71) Applicant: Multi-Chem Group, LLC, Houston, TX (US)

(72) Inventors: Janet Linh Ngo, Cypress, TX (US); Scot Harris Bodnar, Houston, TX (US); Philipp Prince, Pearland, TX (US)

(73) Assignee: Multi-Chem Group, LLC, Houston, TX (US)

(21) Appl. No.: 16/733,084

(22) Filed: Jan. 2, 2020

(51) Int. Cl. C09K 8/524; E21B 37/06

(52) U.S. Cl. CPC C09K 8/524; E21B 37/06

(57) ABSTRACT

A method of wax treatment in subsea well may comprise providing a treatment fluid comprising a base fluid and a hyperbranched polymeric additive. The method may further comprise introducing the treatment fluid into the subsea well through an umbilical line.

### BACKGROUND

In Deepwater applications there are many challenges to address. Hydrocarbon mixtures, such as crude oils and certain fuel oils derived therefrom, may contain considerable amounts of wax. The wax present in crude oils and fractions thereof primarily comprises paraffins but may also contain some non-linear alkanes. Consequently, paraffin wax depositions often occur when crude oil or other hydrocarbons are produced or transported. Like scales, the formation of paraffin wax obstructs the fluid flow through the pipeline, thereby interfering with production and transportation of hydrocarbons.

Several methods exist to prevent or mitigate wax induced flow impairment. Examples include the insulation or heating of conduits, thus maintaining a high temperature of the fluids, regular “pigging” of flowlines, which comprises a method of mechanically scraping the inside of the flowlines in order to remove the deposits. However, these methods are not always possible or economically viable. More specifically, with wax treatment using chemicals, the major difficulty is balancing antagonistic physical properties with requirements for a wax inhibitor product to perform effectively. For example, a dilute product may be pumpable and may have a low pour point, but it may be so dilute that the volume to be shipped and pumped is unrealistic in regard to storage space or pump capacity. Moreover, wax inhibitors are designed to mimic the wax they are meant to treat, hence there is an affinity of the wax product to the problematic wax. Therefore, this design leads to problems caused by poor physical properties, such as high viscosity and/or high pour points. Finally, as an additional challenge, in most cases, deck space and storage on a platform are limited, incentivizing treatment chemicals to have as high an activity as possible to limit the areas and volumes they may require for staging prior to application. Typically, the higher the activity of a wax product, the more viscous it becomes, and the less thermally stable it becomes.

Chemical families commonly associated with Deepwater wax treatment include comb-polymers and the like. Traditional comb-polymers are capable of treating wax problems, but their physical properties, inherent to the polymer structure, lead to entanglement of the polymer chains, which results in high viscosity, and can also lead to other negative physical effects such as higher pour points, or gelation. Typically, these commonly used treatments cannot address wax product umbilical line application difficulties. For example, the commonly used treatments do not allow for acceptably low pour point or acceptably high activity, and they generally do not meet industry standards for umbilical line applications.

### BRIEF DESCRIPTION OF THE DRAWINGS

These drawings illustrate certain aspects of some of the embodiments of the present disclosure and should not be used to limit or define the disclosure.

FIG. 1 is a schematic illustration of an offshore production platform applicable to umbilical applications and treatment fluids in accordance with some embodiments.

FIG. 2 is a side elevation view of an embodiment of an umbilical assembly in accordance with some embodiments.

FIG. 3 is a graphical illustration of comparative Cold Finger testing results including the treatment fluid in accordance with some embodiments.

FIG. 4 is a graphical illustration of the viscosity to pressure results for a treatment fluid comprising 10% hyperbranched polymer in accordance with some embodiments.

### DETAILED DESCRIPTION

The present disclosure is directed to subterranean operations and, more particularly, to a treatment fluid comprising hyperbranched polymeric additives for deepwater wax treatment and umbilical line applications. As used herein, the terms “umbilical” and “umbilical line” are used interchangeably. The methods and compositions disclosed herein may be utilized in deepwater environments to prevent or mitigate wax induced flow impairment. Moreover, embodiments of the methods and compositions disclosed herein may provide a treatment fluid with acceptably low pour point and/or an acceptable high activity while meeting industry standards and requirements for umbilical applications.

Deepwater environments and definitions have changed through the decades as oil and gas capabilities and technology have transformed. As used herein, a deepwater environment may be defined as subsea wellheads at a depth of about 300 meters (“n”) or greater, whereas “ultra-Deepwater” may be defined as subsea wellheads at depths of about 1500 meters or greater.

Generally, problems associated with wax treatment products include high viscosity, dilution problems, high pour points and poor physical properties behavior in general, including low temperature stability. However, embodiments of the treatment fluid disclosed herein comprising hyperbranched polymeric additives may result in formulating higher activity, lower pour point, and lower viscosity; thereby resulting in compositions that may be more beneficial in umbilical applications than traditional additives, such as comb-polymers.

The treatment fluid may comprise a base fluid and a hyperbranched polymeric additive. The treatment fluid may further comprise additional additives, for example, to enhance the physical properties of the hyperbranched polymeric additives and their applicability to Deepwater environments.

Suitable base fluids may be aqueous-based, oil-based, or combinations thereof. Thus, suitable base fluids in treatment fluids disclosed herein, for use in conjunction with various methods, may include, but are not limited to, oil-based fluids, aqueous-based fluids, aqueous-miscible fluids, water-in-oil emulsions, or oil-in-water emulsions.

Aqueous-based fluids suitable for use in treatment fluids disclosed herein may include any of a variety of aqueous fluids suitable for use in subterranean applications more specifically, the aqueous fluid may comprise fresh water, saltwater (e.g., water containing one or more salts dissolved therein), or seawater. Suitable saltwater may include a brine, such as a sodium chloride brine, a sodium bromide brine, a calcium chloride brine, a calcium bromide brine, a zinc bromide brine, a sodium formate brine, a potassium formate brine, and combinations thereof. Generally, the aqueous fluid may be from any source that does not contain an excess of compounds that may undesirably affect other components in the treatment fluid. The aqueous fluid typically may be present in the treatment fluid in an amount up to about 99% by volume of the treatment fluid. By way of example, the aqueous-based fluid may be present in the treatment fluid in an amount of about 50% to about 99% by volume. Alternatively, the aqueous-based fluid may be present in the treatment fluid in an amount of about 50% to about 99% by volume, about 60% to about 90%, or about 70% to about 80% by volume.

Suitable oil-based fluids may include alkanes, olefins, aromatic organic compounds, cyclic alkanes, paraffins, diesel fluids, mineral oils, desulfurized hydrogenated kerosenes, heavy aromatic solvents, xylene, toluene, heavy aromatic naphtha, and any combination thereof. An oil-based fluid may be selected, for example, that may be compatible with the hyperbranched polymeric additive.

The oil-based fluid typically may be present in the treatment fluid in an amount up to about 99% by volume of the treatment fluid. For example, the oil-based fluid may be present in the treatment fluid in an amount of about 50% to about 99% by volume. Alternatively, the oil-based fluid may be present in the treatment fluid in an amount of about 50% to about 99% by volume, about 60% to about 90%, or about 70% to about 80% by volume of the treatment fluid.

Suitable water-in-oil emulsions, also known as invert emulsions, may have an oil-to-water ratio from a lower limit of greater than about 50:50, 55:45, 60:40, 65:35, 70:30, 75:25, or 80:20 to an upper limit of less than about 100:0, 95:5, 90:10, 85:15, 80:20, 75:25, 70:30, or 65:35 by volume in the base fluid, where the amount may range from any lower limit to any upper limit and encompass any subset there between. It should be noted that for water-in-oil and oil-in-water emulsions, any mixture of the above may be used including the water being and/or comprising an aqueous-miscible fluid.

Suitable hyperbranched polymeric additives may include hyperbranched polymers and hyperbranched polymer derivatives. The derivation of hyperbranched polymers may include, but is not limited to, step growth polycondensations, self-condensing vinyl polymerization, and multi-branching ring opening polymerization. The resulting hyperbranched polymers may include, but are not limited to, hyperbranched polyesters, hyperbranched polyamides, hyperbranched polyesteramides, and combinations thereof. Moreover, if the hyperbranched polymer is terminated with an appropriate functional group that may be functionalized further on the periphery, then additional derivatization and physical property modification may be tailored into the final chemistry. In some embodiments, the hyperbranched polyesteramides may be a condensation polymer containing ester groups and at least one amide group in the backbone, having at least one hydroxyalkylamide end group.

Suitable hyperbranched polymer derivatives may include, but are not limited to, the standard classes of hyperbranched polymers generally described above, wherein the standard classes of hyperbranched polymers may then be derivatized to alter their physical properties, thereby making them viable for wax inhibitor or wax dispersant products. Generally, these derivatives may include, but are not limited to, long alkyl chains to mimic the properties of the wax, wherein long alkyl chains comprise C12 to C30 carbons.

The hyperbranched polymeric additive may be included in the treatment fluids in any suitable amount, including an amount of about 1% to about 50% by weight of the treatment fluid. Alternatively, the hyperbranched polymeric additive may be present in amount of about 1% to about 50%, about 5% to about 45%, about 10% to about 40%, about 15% to about 35%, or about 20% to about 30% by weight of the treatment fluid.

Moreover, in some embodiments whereby a system with obvious dependencies may be treated, the hyperbranched polymeric additive may be included in the treatment fluids in an amount of about 200 ppm to about 6000 ppm. Alternatively, the hyperbranched polymeric additive may be included in the treatment fluids in an amount of about 200 ppm to about 6000 pm, about 250 ppm to about 5000 ppm, about 300 ppm to about 4000 ppm, about 400 ppm to about 3000 ppm, or about 500 ppm to about 2000 ppm.

The term “hyperbranched polymer,” as referred to herein, may be defined as any polymer in which the structural repeating unit (specified by IUPAC as “constitutional repeating unit”) has a connectivity of more than two. Hyperbranched polymers are highly branched three-dimensional (3D) macromolecules in which all bonds converge to a focal point or core and have a multiplicity of reactive chain-ends. Their globular and dendritic architectures endow them with unique structures and properties, such as abundant functional groups, intramolecular cavities, low viscosity, and high solubility. The inherent physical properties of hyperbranched polymers should allow for higher activity product formulations while still achieving necessary physical property requirements for umbilical applications, such as low pour points, relatively low viscosity at high pressures, and thermal stability in low temperature environments, wherein the temperature my range, for example, from about 0° C. to about 5° C.

The treatment fluids may have a pour point that may be acceptable as desired for a particular application. As referred to herein, the pour point is the lowest temperature at which a liquid may remain pourable. Alternatively, the pour point is the lowest temperature at which a liquid behaves as a fluid. Oil or synthetic muds with high pour points may surer from poor screening and excessive pressure surges in Deepwater environments or other operations subject to low temperatures. In oils, the pour point is generally increased with a high paraffin contact. Acceptable pour points may be regionally dependent. For example, acceptable pour points in Canada may be about −40° C. while acceptable pour points in the Gulf of Mexico may be about −1.1° C. The treatment fluids disclosed herein may be used across geographical regions. Therefore, the resulting pour point for treatment fluids disclosed herein comprising hyperbranched polymeric additives used in umbilical applications may be about −60° C. to about −5° C. or about −40° C. to about −1.1° C. As used herein, pour points are determined using the method described in ASTM D97.

In addition to pour point, viscosity is another property of the treatment fluids that may be acceptable by use of the hyperbranched polymeric additives. For example, the viscosity of the treatment fluids disclosed herein comprising hyperbranched polymeric additive used in umbilical applications may be from about 0.1 mPa-s to about 100 mPa-s at a reference pressure of about 69,000 kPa. Alternatively, the viscosity of the treatment fluids may be from about 0.1 mPa-s to about 100 mPa-s, about 10 mPa-s to about 90 mPa-s, about 20 mPa-s to about 80 mPa-s, about 30 mPa-s to about 70 mPa-s, or about 40 mPa-s to about 60 mPa-s at a reference pressure of about 70,000 kPa. The corresponding pressure may range from atmospheric to about 172,000 kPa. The viscosity may be relatively lower, depending on system conditions, such as pressure. However, the viscosity may be higher, depending on the equipment and hardware that may be used to pump or move the treatment fluid.

The thermal stability of the hyperbranched polymeric additive may be defined herein as its ability to resist the effects of the low temperatures of the deepwater environment, most commonly associated with an ocean floor temperature of about 4° C., and to maintain its fluid properties, while avoiding changes such as phase separation, particle or solid formation, and no indication of gelling. Moreover, at lower temperatures, the treatment fluid comprising the hyperbranched polymeric additive may remain pourable and essentially without phase separation or gelling. The thermal stability of the hyperbranched polymeric additive may be further defined herein as its ability to resist the effects of the higher temperatures within the deepwater environment, such as storage in direct sun, while maintaining its properties, including its chemical structure and all associated physical properties inherent to its chemistry, but also as a formulated product essentially without gelling, decomposition, or phase separation.

In addition to the hyperbranched polymeric additives, the treatment fluid may comprise any number of suitable additives, including, but are not limited to, surfactants, gas, foamers, corrosion inhibitors, biocides, antifoam agents, dispersants, flocculants, H₂S scavengers, CO₂ scavengers, oxygen scavengers, and any combination thereof. One of ordinary skill in the art should be able to recognize and select suitable additives for use in the treatment fluid with the benefit of this disclosure. For example, the additives may be present in an amount ranging from about 0.01% to about 25% by volume of the treatment fluid. Alternatively, the additives may be present in an amount of about 0.01% to about 25%, 1% to about 24%, 5% to about 20%, or about 10% to about 15% by volume of the treatment fluid.

As will be appreciated by those of ordinary skill in the art, embodiments of the treatment fluids comprising the hyperbranched polymeric additives may be used in a variety of subterranean applications for wax treatment. For example, methods of wax treatment may comprise providing a treatment fluid comprising a base fluid and a hyperbranched polymeric additive. The treatment fluid may be introduced into a subsea well through an umbilical line. By way of example, the treatment fluid may be introduced into the subsea well through a subsea wellhead by the umbilical line. The umbilical line may extend from an offshore platform to the well. Suitable offshore platforms may include, but are not limited to, fixed platforms, semi-submersible platforms, and drill ships, among others.

In the subsea well, the method may further comprise introducing the treatment fluid into a conduit used for the production or transmission of hydrocarbons. The hyperbranched polymeric additive may be added to the system far enough upstream where the production fluids are still above the Wax Appearance Temperature (WAT). If the treatment fluid further comprises a dispersant, then it may be introduced as far upstream as possible for the purpose of immediate interaction with small wax crystals as they form within the production fluids. It may be appreciated by those of ordinary skill in the art, wax inhibitors and dispersants associate with the nucleated wax crystals from the hydrocarbon phase, and thereby prevent further interaction of the nucleated wax crystals with other wax crystals or from depositing on walls of the production pipe.

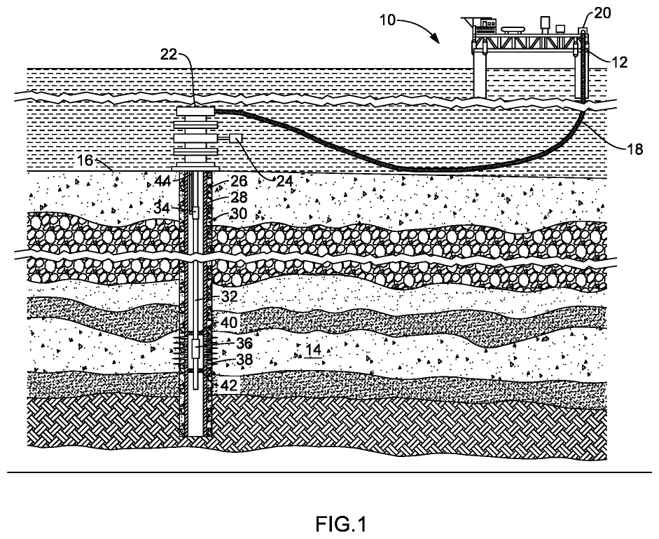

FIG. 1 is a schematic illustration of an offshore production platform applicable to embodiments of umbilical applications and treatment fluids disclosed herein. A semi-submergible production platform 12 may be positioned generally above a submerged oil and gas formation 14 located below a sea floor 16. An umbilical assembly 18 may extend from control unit 20 on platform 12 to a subsea wellhead 22 at sea floor 16. Umbilical assembly 18 may be flexible and able to adopt to the ocean currents as well as any drift of the surface installation 12. The treatment fluid comprising a hyperbranched polymer may be injected into the subsea environment through the umbilical assembly 18. A subsea intensifier 24 may be operably associated with subsea wellhead 22 and may be in fluid communication with umbilical assembly 18. A wellbore 26 may extend from wellhead 22 through various earth strata including formation 14. A casing 28 may be cemented within wellbore 26 by cement 30. A production tubing 32 may be positioned within casing 28. Tubing string 32 may include a subsurface safety valve 34. In addition, tubing string 32 may have a sand control screen 36 positioned proximate subsea wellhead 14 such that production fluids may be produced through perforations 38 and into tubing string 32. A pair of packers 40, 42 may isolate the production interval between tubing string 32 and casing 28. A hydraulic control line 44 may extend from subsea intensifier 24 to subsurface safety valve 34. Even though FIG. 1 depicts a vertical well, it should be noted by one skilled in the art that the assembly may be equally well-suited for use in deviated wells, inclined wells, horizontal wells and other types of well configurations. In addition, even though FIG. 1 depicts a production well, it should be noted by one skilled in the art that the assembly may be equally well-suited for use in injection wells.

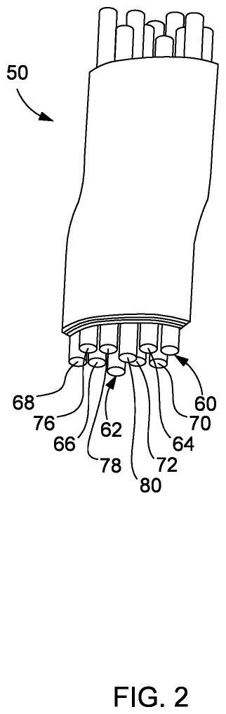

FIG. 2 is a side elevation view of an embodiment of an umbilical assembly as disclosed herein. The umbilical assembly 50 may include a plurality of passageways 60 housed within. Passageways 60 may be fluid passageways 62, such as hydraulic fluid passageways 64, 66 or production fluid passageways 68, 70, 72. Fluid passageways 62 may comprise a protective sheath defining a fluid cavity that may be compatible with a variety of fluids, including the treatment fluid comprising hyperbranched polymers as disclosed herein. In addition, some passageways, such as passageways 76, 78, 80 may house electrical power conduits or electrical signal conduits. Electrical power conduits and electrical signal conduits may include one or more copper wires, multi-conductor copper wires, braided wires, or coaxial woven conductors bounded in a protective sheath.

Accordingly, the methods, compositions, and systems disclosed herein may be directed to wax treatment in a subsea well. The methods, compositions, and systems may include any of the various features of the methods, compositions, and systems disclosed herein, including one or more of the following statements:

Statement 1. A method of wax treatment in a subsea well may comprise providing a treatment fluid comprising a base fluid and a hyperbranched polymeric additive; and introducing the treatment fluid into the subsea well through an umbilical line.

Statement 2. The statement of claim 1, wherein the treatment fluid has a pour point of about −60° C. to about −10° C.

Statement 3. The statement of statements 1 or 2, wherein the treatment fluid has a viscosity of about 0.1 mPa-s to about 100 mPa-s at 4° C.

Statement 4. The method of any of the preceding statements further comprising introducing the treatment fluid comprising the hyperbranched polymeric additive into a conduit used for the transmission of hydrocarbons.

Statement 5. The method of any of the preceding statements, wherein the hyperbranched polymeric additive comprises at least one polymer selected from the group consisting of a hyperbranched polymer, a hyperbranched polymer derivative, and combinations thereof.

Statement 6. The method of any of the preceding statements, wherein the hyperbranched polymeric additive comprises at least one hyperbranched polymer selected from the group consisting of a hyperbranched polyester, a hyperbranched polyamide, a hyperbranched polyesteramide, and combinations thereof.

Statement 7. The method of any of the preceding statements, wherein the hyperbranched polymeric additive comprises a hyperbranched polyesteramide, wherein the hyperbranched polyesteramide comprises a condensation polymer comprising a backbone, wherein the condensation polymer comprises ester groups and at least one amide group in the backbone, and wherein the condensation polymer further comprises at least one hydroxyalkylamide end group.

Statement 8. The method of any of the preceding statements, wherein the subsea well is in a Deepwater environment at a depth of about 300 meters or greater.

Statement 9. The method of any of the preceding statements, wherein the base fluid comprises at least one fluid selected from the group consisting of an aqueous-based fluid, an oil-based fluid, and combinations thereof.

Statement 10. The method of any preceding statement, wherein the base fluid comprises at least one water selected from the group consisting of fresh water, saltwater, seawater, and combinations thereof.

Statement 11. The method of any preceding statement, wherein the base fluid comprises at least one selected from the group consisting of alkanes, olefins, aromatic organic compounds, cyclic alkanes, paraffins, diesel fluids, mineral oils, desulfurized hydrogenated kerosenes, and combinations thereof.

Statement 12. The method of any preceding statement, wherein the base fluid comprises an oil-based fluid, wherein the oil-based fluid is present in an amount of about 50% to about 99% by volume of the treatment fluid.

Statement 13. The method of any preceding statement, wherein the base fluid comprises a brine, wherein the brine comprises at least one brine selected from the group consisting of sodium chloride brine, potassium formate brine, and combinations thereof

Statement 14. The method of any one of claims 1 to 11 or 13, wherein the base fluid comprises an aqueous-based fluid, wherein the aqueous-based fluid is present in an amount of about 50% to about 99% by volume of the treatment fluid

Statement 15. A method of wax treatment in a subsea well may comprise providing a treatment fluid comprising an oil-based fluid and a hyperbranched polymeric additive, wherein the treatment fluid has a pour point of about of about −60° C. to about −10° C.; and introducing the treatment fluid comprising the hyperbranched polymeric additive into a conduit in the subsea well through an umbilical line, wherein hydrocarbons are produced or transmitted through the conduit, and wherein the subsea well is in a Deepwater environment at a depth of about 300 meters or greater.

Statement 16. The method of statement 15, wherein the pour point of the treatment fluid is about −40° C. to about −1.1° C.

Statement 17. The method of statement 15 or 16, wherein the treatment fluid has a viscosity of about 0.1 mPa-s to about 100 mPa-s.

Statement 18. The method of statements 15, 16, or 17, wherein the oil-based fluid comprises at least one solvent selected from the group consisting of heavy aromatic naphtha, xylene, toluene, and combinations thereof.

Statement 19. The method of statements 15, 16, 17, or 18 wherein the hyperbranched polymeric additive comprises at least one polymer selected from the group consisting of a hyperbranched polyester, a hyperbranched polyamide, a hyperbranched polyesteramide, and combinations thereof

Statement 20. The method of statements 15, 16, 17, 18, or 19, wherein the hyperbranched polymeric additive comprises a hyperbranched polyesteramide, wherein the hyperbranched polyesteramide comprises a condensation polymer comprising a backbone, wherein the condensation polymer comprises ester groups and at least one amide group in the backbone, and wherein the condensation polymer further comprises at least one hydroxyalkylamide end group

To facilitate a better understanding of the present disclosure, the following examples of certain aspects of some of the systems and methods are given. In no way should the following examples be read to limit, or define, the entire scope of the disclosure.

### Example 1

Tis example was performed to compare a treatment fluid comprising a hyperbranched polymeric additive as disclosed herein with a treatment fluid comprising a traditional wax inhibitor. The hyperbranched polymeric additive was blended with a non-ionic surfactant at 1% to 15% by weight in heavy aromatic naphtha (HAN 100). A conventional wax inhibitor, olefin maleic anhydride co-polymer derivative (OMAC) was blended with the same non-ionic surfactant at 1% to 15% by weight in xylene. The percent by volume (or “activity”) of the hyperbranched polymeric additive and the OMAC was varied, as shown in Table 1 below. The treatment fluids were aged for a period of 28 days at various temperatures. The test temperatures for the treatment fluids with the hyperbranched polymeric additive ranged from about −1° C. to about −40° C., while the test temperatures for the treatment fluids comprising the OMAC ranged from 10° C. to about −7° C. The results are provided in Table 1 below.

TABLE 1

| | |
|---|---|
| Hyperbranched | 28 days |

| Polymeric Additive | −1° C. | −18° C. | −29° C. | −40° C. |
|---|---|---|---|---|
| 30% active | Liquid | Liquid | Solid | Solid |
| 20% active | Liquid | Liquid | Liquid | Solid |
| 10% active | Liquid | Liquid | Liquid | Liquid |
| 5% active | Liquid | Liquid | Liquid | Liquid |

28 days

| OMAC | 10° C. | 4° C. | −1° C. | −7° C. |
|---|---|---|---|---|
| 30% active | Solid | Solid | Solid | Solid |
| 20% active | Liquid | Solid | Solid | Solid |
| 10% active | Liquid | Liquid | Solid | Solid |
| 5% active | Liquid | Liquid | Solid | Solid |

As shown in Table 1, the treatment fluid comprising the hyperbranched polymeric additive allowed for higher activity product formulations while still achieving thermal stability in low temperature environments. For example, at 30% activity, the treatment fluid comprising the hyperbranched polymeric additive maintained its liquid phase at temperatures as low as −18° C., whereas the treatment fluid comprising OMAC in xylene transitioned to a solid phase at a temperature as high as 10° C. At 20% activity, the treatment fluid comprising the hyperbranched polymeric additive maintained its liquid phase at temperatures as low as −29° C., whereas the treatment fluid comprising OMAC in xylene transitioned to a solid phase at temperatures as high as 4° C. Moreover, at 10% and 5% activity, the treatment fluid comprising the hyperbranched polymeric additive composition maintained its liquid phase at temperatures as low as −40° C., whereas the treatment fluid comprising OMAC in xylene transitioned to a solid phase at temperatures as high as −7° C.

### Example 2

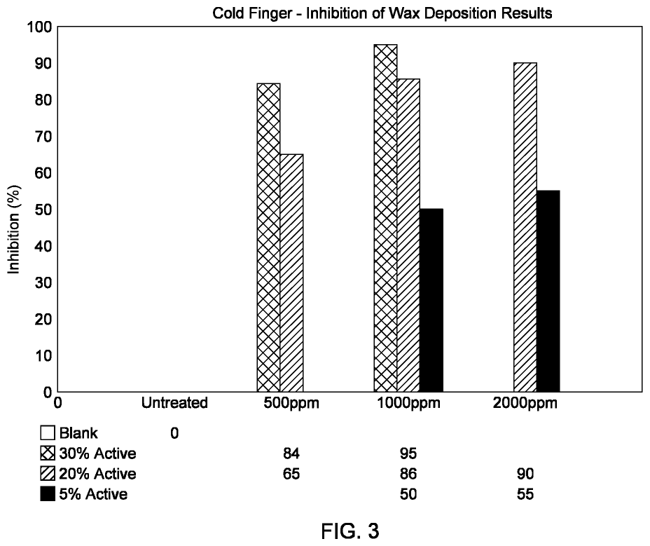

Cold Finger testing was performed to further evaluate treatment fluids comprising hyperbranched polymeric additive. The Cold Finger testing was performed using the treatment fluids comprising 5%, 20%, and 30% by weight of the hyperbranched polymeric additive prepared in Example 1 at various dosage rates, as depicted in FIG. 3. All results are compared relatively to a blank control. In the Cold Finger testing, a Cold Finger instrument was used to calculate the wax inhibition efficiency of the hyperbranched polymeric additive disclosed herein versus a blank without treatment. The instrument's cooled metal finger replicates the inner wall of a pipeline. The test involves the immersion of a series of tubes in molten crude oil. The temperature of the tubes my be colder than the oil, such that the waxes from the oil may deposit on the cooler surfaces. The wax deposits may then be weighed. With the addition of an effective wax inhibitor, the weight of the deposits should decrease and may be presented as a percentage of wax inhibition. When the finger's temperature falls below the Wax Appearance Temperature (WAT), wax may begin to deposit on its surface. As the Cold Finger instrument may replicate a pipeline environment, the results may be transferable to how the treatment fluid comprising hyperbranched polymeric additives may perform in field conditions.

FIG. 3 is a graphical illustration of comparative Cold Finger testing results, including the treatment fluid comprising hyperbranched polymeric additive disclosed herein. Cold Finger testing results of at least 50% inhibition may be considered as efficient performance, wherein the maximum level of inhibition is 100%. If a product is already being used in the field and can be included in the testing, this is ideal to compare relative performance against the standard (incumbent) and the newly considered products. The minimum level of inhibition may be reached even at a dose rate of 500 ppm at both 20% and 30% active content, wherein the minimum level of inhibition is 50%. Higher active content treatment fluids may be preferred, as space is limited on Deepwater treatment facilities.

### Example 3

This example was performed to further evaluate treatment fluids comprising hyperbranched polymeric additive. In this example, the treatment fluid comprising 10% by volume of the hyperbranched polymeric additive from Example 1 was evaluated. In particular, the viscosity of the treatment fluid as a function of pressure was determined by high pressure viscometer testing performed at a temperature of 4° C.

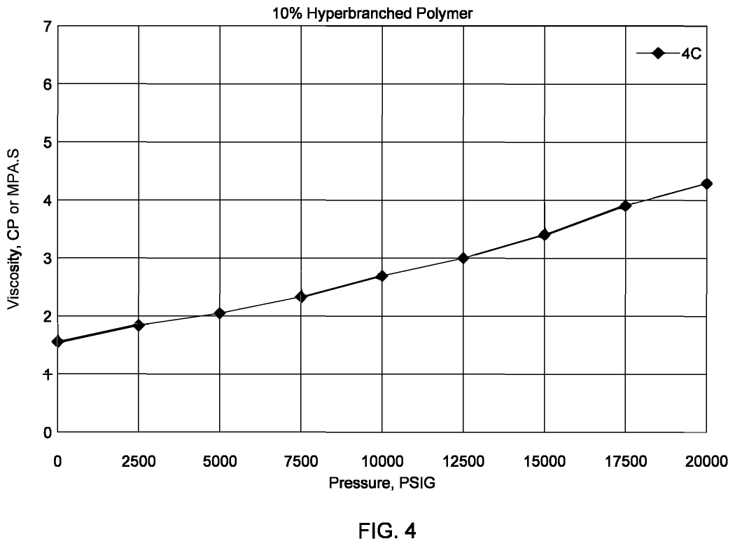

FIG. 4 is a graphical illustration of the viscosity to pressure results for the treatment fluid comprising 10% hyperbranched polymeric additive in HAN 100 as disclosed herein. For the embodiments disclosed herein, 100 cP at 10,000 psi may be the upper limit for viscosity. The treatment fluid comprising the hyperbranched polymeric additive has a viscosity of 2.8 cP at 10,000 psi, and a viscosity of only 4.4 cP at 20,000 psi. The significance of this data is that, by comparison, traditional wax treatment products that are in the comb polymer chemical family would have viscosities in excess of 100 cP at 10,000 psi at 4° C. Moreover, unlike hyperbranched polymeric additives, traditional polymers would require dilution to a comparatively low activity percentage in order to achieve the same viscosity profile. Consequently, the use of traditional polymers would not be logistically feasible because they would be comprised mainly of solvent; thereby, requiring large volumes being pumped in relatively short time periods in order to provide effective treatment.

It should be understood that, although individual examples may be discussed herein, the present disclosure covers all combinations of the disclosed examples, including, without limitation, the different component combinations, method step combinations, and properties of the system.

It should be understood that the compositions and methods are described in terms of “comprising,” “containing,” or “including” various components or steps, the compositions and methods may also “consist essentially of” or “consist of” the various components and steps. Moreover, the indefinite articles “a” or “an,” as used in the claims, are defined herein to mean one or more than one of the elements that it introduces.

All numerical values within the detailed description and the claims herein modified by “about” or “approximately” with respect to the indicated value are intended to consider experimental error and variations that would be expected by a person having ordinary skill in the art.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

What is claimed is:

1. A method of wax treatment in a subsea well comprising:
providing a treatment fluid comprising a base fluid and a hyperbranched polymeric additive; and
introducing the treatment fluid into the subsea well through an umbilical line.

2. The method of claim 1, wherein the treatment fluid has a pour point of about −60° C. to about −10° C.

3. The method of claim 1, wherein the treatment fluid has a viscosity of about 0.1 mPa-s to about 100 mPa-sat 4° C.

4. The method of claim 1 further comprising introducing the treatment fluid comprising the hyperbranched polymeric additive into a conduit used for the transmission of hydrocarbons.

5. The method of claim 1, wherein the hyperbranched polymeric additive comprises at least one polymer selected from the group consisting of a hyperbranched polymer, a hyperbranched polymer derivative, and combinations thereof.

6. The method of claim 1, wherein the hyperbranched polymeric additive comprise at least one hyperbranched polymer selected from the group consisting of a hyperbranched polyester, a hyperbranched polyamide, a hyperbranched polyesteramide, and combinations thereof.

7. The method of claim 1, wherein the hyperbranched polymeric additive comprises a hyperbranched polyesteramide, wherein the hyperbranched polyesteramide comprises a condensation polymer comprising a backbone, wherein the condensation polymer comprises ester groups and at least one amide group in the backbone, and wherein the condensation polymer further comprises at least one hydroxyalkylamide end group.

8. The method of claim 1, wherein the subsea well is in a Deepwater environment at a depth of about 300 meters or greater.

9. The method of claim 1, wherein the base fluid comprises at least one fluid selected from the group consisting of an aqueous-based fluid, an oil-based fluid, and combinations thereof.

10. The method of claim 1, wherein the base fluid comprises at least one water selected from the group consisting of fresh water, saltwater, seawater, and combinations thereof.

11. The method of claim 1, wherein the base fluid comprises at least one oil selected from the group consisting of alkanes, olefins, aromatic organic compounds, cyclic alkanes, paraffins, diesel fluids, mineral oils, desulfurized hydrogenated kerosenes, and combinations thereof.

12. The method of claim 1, wherein the base fluid comprises an oil-based fluid, wherein the oil-based fluid is present in an amount of about 50% to about 99% by volume of the treatment fluid.

13. The method of claim 1, wherein base fluid comprises a brine, wherein the brine comprises at least one brine selected from the group consisting of sodium chloride brine, potassium formate brine, and combinations thereof.

14. The method of claim 1, wherein the base fluid comprises an aqueous-based fluid, wherein the aqueous-based fluid is present in an amount of about 50% to about 99% by volume of the treatment fluid.

15. A method of wax treatment in a subsea well comprising:
providing a treatment fluid comprising an oil-based fluid and a hyperbranched polymeric additive, wherein the treatment fluid has a pour point of about of about −60° C. to about −10° C.; and
introducing the treatment fluid comprising the hyperbranched polymeric additive into a conduit in the subsea well through an umbilical line, wherein hydrocarbons are produced or transmitted through the conduit, and wherein the subsea well is in a Deepwater environment at a depth of about 300 meters or greater.

16. The method of claim 15, wherein the pour point of the treatment fluid is about −40° C. to about −1.1° C.

17. The method of claim 15, wherein the treatment fluid has a viscosity of about 0.1 mPa-s to about 100 mPa-s.

18. The method of claim 15, wherein the oil-based fluid comprises at least one solvent selected from the group consisting of heavy aromatic naphtha, xylene, toluene, and combinations thereof.

19. The method of claim 15 wherein the hyperbranched polymeric additive comprises at least one polymer selected from the group consisting of a hyperbranched polyester, a hyperbranched polyamide, a hyperbranched polyesteramide, and combinations thereof.

20. The method of claim 15, wherein the hyperbranched polymeric additive comprises a hyperbranched polyesteramide, wherein the hyperbranched polyesteramide comprises a condensation polymer comprising a backbone, wherein the condensation polymer comprises ester groups and at least one amide group in the backbone, and wherein the condensation polymer further comprises at least one hydroxyalkylamide end group.
